(19) United States
(12) Patent Application Publication
(10) Pub. No.: US 2010/0291399 A1
(43) Pub. Date: Nov. 18, 2010

(54) LID FOR A FUNCTIONAL PART AND A PROCESS FOR ITS MANUFACTURE

(76) Inventors: Rikiya Kato, Saitama (JP); Mitsuo Zen, Saitama (JP)

Correspondence Address: MICHAEL TOBIAS, 1629 K ST NW, SUITE 300, WASHINGTON, DC, 20006, US

(21) Appl. No.: 12/310,516

(22) PCT Filed: Sep. 3, 2007
(86) PCT No.: PCT/JP2007/067144

§ 371 Date: Jul. 28, 2010

(30) Foreign Application Priority Data
Sep. 1, 2006 (JP) 2006-237259

(51) Int. Cl. B32B 15/02; B23K 1/20

(52) U.S. Cl. 428/553; 228/141.1

(57) ABSTRACT

As a replacement for high-temperature solder having a solidus temperature of at least 250° C. for bonding a package and a lid of a functional part, a solder paste formed by mixing a Cu-based metal powder with a solidus temperature of at least 400° C. and an Sn-based solder powder is applied to a lid of a difficult to solder material which was previously subjected to plating having good solderability and heated to obtain a solder layer comprising the Cu-based metal powder, Cu₆Sn₅ intermetallic compounds, and lead-free solder on the plated surface. The intermetallic compounds are bonded to the difficult to solder material and the intermetallic compounds are connected to each other, so the solder layer functions as a high-temperature solder. The problem of poor solderability of high-temperature solders is avoided by the present invention.

### TECHNICAL FIELD

This invention relates to a lid for sealing a package for a functional part and particularly a functional part having an element housed inside the package in an airtight manner. It also relates to a process for manufacturing the lid.

### BACKGROUND ART

Functional parts such as quartz crystal units, SAW filters, and sensors have an element housed inside a package which is covered by a lid so as to maintain airtightness. Adhesives, brazing filler alloys, and solders are used to seal the package with the lid in an airtight manner, but from the standpoint of ease of sealing operations and economy of materials, it is preferable to use solder. A package is made of a ceramic such as alumina, aluminum nitride, mullite, or a glass-ceramic and cannot be soldered as is. In order to join such a package to a lid, part of the surface of the package to which a lid is to be joined is subjected to metallization with tungsten, molybdenum, or the like and then to plating with Ag—Pt, Ni, Au or the like on which soldering can be performed.

A lid is formed of a Fe—Ni based alloy such as Kovar (Fe-29Ni-17Co) or Alloy 42 (Fe-42Ni). A material for forming a lid (lid material) which is a sheet of such a Fe—Ni based alloy is formed into a lid having a shape corresponding to the shape and dimensions of a package. Fe—Ni based alloys are used for lids because these Fe—Ni alloys have a coefficient of thermal expansion which is close to that of ceramics. This is because the lid and the package are heated when soldering a lid to a package and when soldering a functional part to a printed circuit board. If there is a large difference in thermal expansion between the package and the lid, due to the strains which develop in the two members, the relatively brittle package may be destroyed or cracked.

A functional part formed by joining a package and a lid with solder is mounted on a printed circuit board. Mounting of a functional part on a printed circuit board is carried out by soldering. If the previously soldered joint between the package and lid melts when performing soldering at the time of mounting, the problems occur that the lid peels off the package or its position deviates. Therefore, a high-temperature solder which does not melt at the soldering temperature of solder used for mounting of functional parts is used as a solder for joining a package and a lid.

In the past, solder used for mounting of functional parts was Pb-63Sn, which is a Pb-based eutectic solder. In general, a soldering temperature which is 30-50° C. above the liquidus temperature of solder is considered appropriate. A Pb-based eutectic solder has a liquidus temperature of 183° C., so the soldering temperature with this eutectic solder is 210-230° C. Accordingly, when mounting a functional part using a Pb-based eutectic solder, if the above-described high-temperature solder has a solidus temperature of at least 240° C., the high-temperature solder does not melt at the time of mounting of the functional part and the lid does not peel off the package. With functional parts using a Pb-based eutectic solder for mounting, a high-temperature solder having Pb as a main component such as Pb-5Sn (solidus temperature of 300° C., liquidus temperature of 314° C.), Pb-2.5Ag (solidus temperature of 304° C., liquidus temperature of 304° C.), and the like is used when soldering the package and the lid.

However, because the harmful effects of lead are becoming a problem, the use of Pb is now regulated on a global scale. Of course, a Pb-based eutectic solder which contains Pb is also the subject of regulation. Therefore, so-called lead-free solders which do not contain Pb have come to be used as solders for mounting.

Lead-free solders contain Sn by itself or have Sn as a main component to which Ag, Cu, Sb, Zn, Bi, In, Fe, Ni, Cr, Co, Ge, Ga, P, or the like is added. They can be generally classified as Sn—Ag based solders, Sn—Cu based solders, Sn—Zn based solders, Sn—Sb based solders, Sn—Bi based solders, Sn—In based solders, and the like. Here, “based solders” means these binary alloys themselves or ternary or higher order alloys in which other elements are added to one of these binary alloys. For example, Sn—Ag based alloys include Sn-3.5Ag, Sn-3Ag-0.5Cu, and the like.

As described above, a Pb-based eutectic solder can be used for soldering at a temperature which does not have thermal effects on printed circuit boards or functional parts, and it also has good solderability. Accordingly, there is a demand for lead-free solders which have a soldering temperature and solderability which are close to those of a Pb-based eutectic solder.

One class of lead-free solder having a soldering temperature which is close to that of a Pb-based eutectic solder is an Sn—Zn based solder (Sn-9Zn: solidus and liquidus temperature of 199° C.). However, this class of lead-free solder has poor solderability compared to a Pb-based eutectic solder. In addition, Zn is a base metal and sometimes causes intergranular corrosion after soldering. Therefore, this class of solder is not used much at present.

Sn—Bi based solders have a solidus temperature of 139° C. and do not have a thermal effect on printed circuit boards or semiconductor elements, but their solidus temperature is too low. As a result, when portions which are soldered with this class of solder are disposed in the vicinity of power transistors or transformers which generate heat during use, the bonding strength of the soldered portions becomes weak and they melt. Similarly, Sn—In based alloys, which have a solidus temperature at 117° C., develop problems due to their solidus temperature being too low.

Sn-3.5Ag, which is an Sn—Ag based alloy, has a solidus temperature of 221° C. and a liquidus temperature of 223° C. Therefore, soldering is carried out at around 250° C. Although this soldering temperature is slightly higher than the soldering temperature of a Pb-based eutectic solder, this temperature does not have thermal effects on printed circuit boards or functional parts. Sn—Ag based solders have inferior solderability compared to a Pb-based eutectic solder, but soldering can still be carried out without any problems in actual practice.

Sn-0.7Cu, which is an Sn—Cu based alloy, has a solidus and liquidus temperature of 227° C., and its soldering temperature is a little higher than that of an Sn—Ag based solder. However, no problems occur if suitable temperature control is carried out.

An example of an Sn—Ag based solder is Sn-3Ag-0.5Cu (solidus temperature of 217° C., liquidus temperature of 220° C.). This lead-free solder not only has the lowest solidus temperature and liquidus temperature among Sn—Ag based solders, but it also has better solderability than an Sn—Cu based solder. Accordingly, Sn-3Ag-0.5Cu is currently much used as a lead-free solder for replacing a Pb-based eutectic solder.

As already stated, when soldering a package and a lid of a functional part to each other, it is necessary to use a high-temperature solder which does not melt at the soldering temperature used when mounting the functional part. Since a Pb-based eutectic solder can no longer be used for mounting of functional parts, Sn-3Ag-0.5Cu is widely used for mounting, but the soldering temperature is 240-250° C. when using this lead-free solder. Accordingly, a lead-free high-temperature solder for soldering a package and a lid to form a functional part must have a solidus temperature of 250° C. or above.

However, there was no high-temperature Sn-based lead-free solder which had a solidus temperature of at least 250° C. and a liquidus temperature of at most 300° C., which is the heat resisting temperature of functional parts. Even if the amount of high melting point metals such as Cu, Ag, or Sb in an Sn-based solder is increased so as to produce a high-temperature solder, only the liquidus temperature rises while the solidus temperature is 250° C. or lower. For example, Sn-5Cu, which contains a large amount of Cu, has a solidus temperature of 227° C. and a liquidus temperature of 375° C. Sn-5Ag, which contains a large amount of Ag, has a solidus temperature of 221° C. and a liquidus temperature of 245° C. Similarly, Sn-10Sb, which contains a large amount of Sb, has a solidus temperature of 245° C. and a liquidus temperature of 266° C. If these solders are used for soldering a lid and a package of a functional part and then an Sn-3Ag-0.5Cu solder is used to solder such a functional part to a printed circuit board at 250° C., the previously soldered portions melt or become semi-molten, and the bonding strength between the package and the lid weakens or complete peeling of the lid takes place.

A solder paste for high-temperature solder comprising Sn balls and Cu balls mixed together has been proposed (Patent Documents 1 and 2). This solder paste is used for soldering of electronic equipment. The resulting solder joint is constituted by a Cu-dispersed high-temperature solder, which makes the joint resistant to high temperatures.

Patent Document 1: JP 2002-254194A

Patent Document 2: JP 2002-261105A

### DISCLOSURE OF INVENTION

### Problems which the Invention is to Solve

A Cu-dispersed high-temperature solder has inferior solderability compared to a conventional Pb-based high-temperature solder. In addition, a solder paste of a Cu-dispersed high-temperature solder has problems with respect to the solderability of a package to a lid in a functional part.

Accordingly, even if it is attempted to use a Cu-dispersed high-temperature solder for soldering of a package and a lid of a functional part, it is not possible for the above-described solder paste for high-temperature solder to bond a lid which has poor solderability. A solder paste including flux has problems with respect to the solderability of a lid and a package, and particularly a package of a functional part.

This invention provides a lid for a functional part which can be easily wet at the time of soldering of the lid to a package in spite of using a Cu-dispersed high-temperature solder. The present invention also provides a process for manufacturing the lid.

### Means for Solving the Problem

The present inventors discovered the following and completed the present invention.

(i) If a solder paste comprising solder mixed with a liquid flux is applied to the entire region to be soldered and then heated to melt the solder paste, solder adheres to the entire region to be soldered.

(ii) Solder easily wets a material having poor solderability if the material is plated with a metal having good solderability, whereby solder can adhere to the material.

(iii) Wettability of the entire bonding surface of a package can be guaranteed without using flux, and the bonding strength at a high temperature is improved by previously treating a lid to form a solder layer having Cu metal particles dispersed in solder thereon.

(iv) If a high-temperature solder layer is previously formed, it is not necessary to use flux, and atmosphere soldering becomes possible without any adverse effect on an element housed in a functional part.

The present invention is a lid for a functional part which is bonded to a package using solder, characterized in that the lid comprises a plating layer of a metal having good solderability provided on one side of the lid and a solder layer having a thickness of 5-40 μm which is formed on the surface of the plating layer and which comprises a Cu-based metal powder having a solidus temperature of at least 400° C., Cu₆Sn₅ intermetallic compounds, and an Sn-containing lead-free solder, and in that in the solder layer, the Cu-based metal powder is dispersed in the matrix of the lead-free solder, the Cu₆Sn₅ intermetallic compounds are present in the periphery of the Cu-based metal powder, the intermetallic compounds are bonded to the plated surface, and at least a portion of the intermetallic compounds are connected to each other.

From another standpoint, the present invention is a process for manufacturing a lid for a functional part comprising the following steps:

(A) a step of applying a uniform thickness of a solder paste comprising a Cu-based metal powder with a solidus temperature of at least 400° C., an Sn-containing lead-free solder powder, and a flux to a plated surface of a lid material in sheet form which is plated on one side thereof with a metal having good solderability;

(B) a heating step in which the lid material in sheet form having the solder paste applied thereto is heated to at least the liquidus temperature of the lead-free solder and at most the solidus temperature of the Cu-based metal powder to form a solder layer on the plated surface of the lid material in sheet form with the Cu-based metal powder being dispersed in the matrix of the lead-free solder of the solder layer, and with Cu₆Sn₅ intermetallic compounds being present in the periphery of the Cu-based metal powder and with the intermetallic compounds being bonded to the lid material in sheet form and with at least a portion of the intermetallic compounds being connected to each other;

(C) a step of cleaning the lid material in sheet form having the solder layer formed on one side thereof with a cleaning fluid to completely remove flux residue; and

(D) a step of subjecting the lid material in sheet form from which the flux residue was removed to working to form a lid having a predetermined shape.

From yet another standpoint, the present invention is a functional part in m which a ceramic package and a metal lid having a coefficient of thermal expansion close to that of a ceramic are joined to each other with a solder layer, characterized in that the solder layer has a Cu-based metal powder with a solidus temperature of at least 400° C. dispersed in a matrix of an Sn-containing lead-free solder and that the Cu-based metal powder is surrounded by Cu₆Sn₅ intermetallic compounds, the intermetallic compounds being bonded to a plating layer applied to the package and to a metal plating layer applied to the lid, at least a portion of the intermetallic compounds being connected to each other.

### EFFECTS OF THE INVENTION

A lid for a functional part according to the present invention has a solder layer of a Cu-containing high-temperature solder formed on one side of the lid. Therefore, a functional part can be manufactured simply by placing the lid atop a package and heating, and simple manufacture is possible. Due to the presence of high melting point Cu₆Sn₅ intermetallic compounds (referred to below as CuSn compounds) which are bonded to the lid, when the lid is placed on a package and heated to melt the solder, the lid is soldered to the package without any positional deviation of the solder layer and the lid.

In a process for manufacturing a lid for a functional part according to the present invention, a lid material in sheet form having poor solderability is plated with a metal having good solderability, and a solder paste is applied to one side of the lid material and heated. Therefore, an Sn-containing lead-free solder having poor solderability can be adhered to the lid material with certainty. In addition, in the process according to the present invention, the applied thickness of solder paste is made uniform, so a uniform thickness of the solder layer can be achieved. As a result, a lid obtained by the process according to the present invention not only has no bonding defects when it is bonded to a package, but the airtightness between the lid and the package is improved.

In a functional part having a package and a lid joined by an Sn-containing lead-free solder layer according to the present invention, CuSn intermetallic compounds formed within the solder layer are not only bonded to the plating layer of the package and the plating layer of the lid but are also connected to each other. Accordingly, when such a functional part is mounted on a printed circuit board, the solder layer does not melt even at the soldering temperature (240-250° C.) of a lead-free solder for mounting such as Sn-3Ag-0.5Cu (solidus temperature of 217° C., liquidus temperature of 220° C.), and the lid does not peel off the package or move. Thus, the present invention provides a functional part having good reliability.

The present invention can be applied not only to a flat lid for a box-shaped package but also to a cap-shaped lid for a flat package.

### BRIEF EXPLANATION OF THE DRAWINGS

FIG. 1 shows a step of applying a solder paste in a manufacturing process for a lid according to the present invention, wherein FIG. 1(A-1) is a schematic explanatory view of the application step, FIG. 1(A-2) is a schematic view of a cross section of a lid material in sheet form after application, and FIG. 1(A-3) is an enlarged view of the cross section.

FIG. 2 is an explanatory view of a heating step in the process of the present invention, wherein FIG. 2(B-1) is a schematic explanatory view of a heating furnace in the form of a reflow furnace, FIG. 2(B-2) is a schematic explanatory view of a cross section of a lid material in sheet form which has undergone the heating step, and FIG. 2(B-3) is an enlarged view of a portion of the cross section.

FIG. 3 is a schematic explanatory view of a cleaning step (C) in a manufacturing process for a lid according to the present invention.

FIG. 4 is a schematic explanatory view of a lid-forming step in the manufacturing process for a lid according to the present invention, wherein FIG. 4(D-1) is a schematic explanatory view of a step of forming a lid having a desired shape from a strip of a lid material, and FIG. 4(D-2) is a perspective view of a lid 18 punched from the strip of a lid material 1.

FIG. 5 is a cross-sectional view of a functional part manufactured by a process according to the present invention.

FIG. 6 is an enlarged cross-sectional view of the soldered portion J of FIG. 5.

### BEST MODE FOR CARRYING OUT THE INVENTION

In the present invention, a Fe—Ni based alloy such as Kovar or Alloy 42 is used as a lid. These alloys have a coefficient of thermal expansion which is close to that of a ceramic which is the material of a package, so when a lid and a package are soldered to each other or during heating at the time of mounting a functional part, thermal strains do not develop in either member. However, as these Fe—Ni based alloys have poor solderability, a strip of a lid material in sheet form is previously plated with a metal having good solderability before it is formed into the zo shape of a lid.

Examples of a metal having good solderability with which the lid material in sheet form is plated in the present invention are Sn, Cu, Ag, Sn—Cu alloys, Sn—Ag alloys, and the like. The metal is preferably Sn, Sn—Cu (Cu content of at most 3%), or Sn—Bi (Bi content of at most 3%).

These metals can be plated on the lid material by electroplating, electroless plating, or the like. A suitable plating thickness is 0.5-5 μm. If the plating thickness is less than 0.5 μM, the plating readily diffuses into molten solder at the time of soldering and completely disappears, resulting in poor solderability. If the plating is thicker than 5 μm, a long time is required for plating operations and productivity becomes poor.

In the present invention, a “based alloy” means not only any of the above-described binary alloys but also an alloy in which one or more other metals are added to any of these binary alloys.

A Cu-based metal powder used in the present invention is pure Cu powder or a Cu-based alloy powder having a solidus temperature of at least 400° C. If the solidus temperature of a Cu-based metal powder is less than 400° C., when the powder is formed into a solder paste and heated, the Cu-based metal powder readily melts into molten solder and does not remain in the solder in powder form. Examples of a Cu-based alloy powder are Cu—Sn based alloy powder, Cu—Ag based alloy powder, Cu—Zn based alloy powder, and Cu—Ni based alloy powder. The melting point (solidus temperature) of pure Cu is 1083° C., the solidus temperature of Cu-50Sn is 415° C., the solidus temperature of Cu-28Ag is 780° C., the solidus temperature of Cu-98Zn is 424° C., and the solidus temperature of Cu-10Ni is 1000° C.

A suitable average particle diameter of a Cu-based metal powder used in the present invention is 2-30 μm. If the particle diameter is smaller than 2 μm, the powder readily diffuses into molten solder, while if the particle diameter is larger than 30 μm, the powder interferes with printability. Preferably the particle diameter is 2-15 μm.

A Cu-based metal powder used in the present invention may be subjected to Ni plating. If Cu-based metal powder is plated with Ni, when a solder paste comprising the Cu-based metal powder, an Sn-containing lead-free solder powder, and a flux is applied to a lid material in sheet form and then heated, the reaction between the Cu-based metal powder and the molten lead-free solder is retarded, thereby causing the formation of CuSn compounds which interfere with solderability to occur slowly, and the effects are obtained that voids are minimized and solderability is improved. At the time of this heating, Ni diffuses into the molten lead-free solder, and the reaction of the solder with Cu is suppressed. After a solder layer is formed on the lid material, the lid material in sheet form is formed into the shape of a lid. The resulting lid is mounted on a package and reheated, and at the time of reheating, the Cu-based metal powder and the molten lead-free solder react and form CuSn compounds (Cu₆Sn₅).

When a Cu-based metal powder is plated with Ni, the thickness of the Ni plating is preferably 0.03-0.3 μm. If the plating thickness is less than 0.03 μm, the effect of retarding the formation of CuSn compounds is not obtained, while if the thickness is greater than 0.3 μm, the formation of SnCu compounds does not occur, leading to a failure to improve the heat resistance of a solder layer.

An Sn-containing lead-free solder used in the present invention is pure Sn or an Sn-based solder and preferably an Sn-based alloy containing at least 40 mass % of Sn. An Sn-containing lead-free solder is intended to react with Cu at the time of melting on the surface of particles of a Cu-based metal powder and form CuSn compounds. It is difficult to form CuSn compounds if a lead-free solder does not contain at least 40 mass % of Sn.

Preferred lead-free solders for use in the present invention are pure Sn and Sn-based alloys. Examples of Sn-based alloys are Sn—Ag based alloys, Sn—Cu based alloys, Sn—Sb based alloys, Sn—Zn based alloys, Sn—In based alloys, Sn—Bi based alloys, and the like. Examples of these alloys are Sn-3.5Ag, Sn-0.7Cu, Sn-3Ag-0.5Cu, Sn-9Zn, Sn-52Bi, Sn-58In, and the like.

A suitable average particle diameter of a lead-free solder used in the present invention is 2-30 μm. If the particle diameter is smaller than 2 μm, a large amount of surface oxidation takes place, as a result of which reflow properties become poor zo and the reaction with Cu-based metal powder is retarded. If it is larger than 30 μm, contact with the surface of the Cu-based metal powder decreases and reactivity worsens, there is insufficient agglomeration of solder powder and Cu-based powder, and this impedes the formation of Sn—Cu compounds.

A solder paste used in a manufacturing process for a lid according to the present invention is formed by mixing a Cu-based metal powder, an Sn-containing lead-free solder powder, and a flux to form a paste. A suitable mixing ratio of the Cu-based metal powder and the Sn-containing lead-free solder powder is 15-40 mass % of the Cu-based metal powder and a remainder of the Sn-containing lead-free solder powder. If the content of the Cu-based metal powder is less than 15 mass %, the amount of CuSn compounds formed inside the solder alloy layer becomes small, and the bonding strength in a high-temperature atmosphere weakens. However, if the content of the Cu-based metal powder becomes larger than 40 mass %, the amount of solder becomes small and solderability worsens. The content of the Cu-based metal powder is preferably 25-35 mass %.

In the present invention, solder paste is applied to one side of a lid material in sheet form and heated. A suitable thickness of application of the solder paste is 20-80 μm. If the applied thickness of the solder paste is less than 20 μm, when the solder paste is melted, the thickness of the solder layer formed on the lid material becomes too thin, and when the lid is mounted on a package and heated, the amount of solder becomes too small. As a result, not only does the bonding strength weaken, but the package can no longer be sealed. On the other hand, if the applied thickness of solder paste is greater than 80 μm, the thickness of the solder layer formed on a lid material in sheet form becomes too large, and when the lid is soldered to a package, excess solder penetrates into the package and adheres to the element or sags downward.

In the present invention, after a solder paste is applied to one side of a lid material in sheet form and preferably to the entire surface thereof, the solder paste is heated. The heating temperature at this time is at least the temperature at which the Sn-containing lead-free solder powder in the solder paste melts but at which the Cu-based metal powder does not melt. A suitable heating temperature is 250-300° C. If the heating temperature is 250° C., almost all of the Sn-containing lead-free solder melts and wets the lid material in sheet form, while if it exceeds 300° C., the element housed inside the package undergoes thermal damage and its performance deteriorates.

The flux of the solder paste used in the present invention can be one which is conventionally used in soldering. In general, a flux for solder paste contains solids such as a rosin, an activator, a thixotropic agent, and the like dissolved in a solvent. Such a flux can be used in the present invention.

As is clear from the above-described explanation, when manufacturing a lid according to the present invention, a solder paste as described above is applied to a lid material in sheet form and heated. The Sn in the solder powder which melts at this time alloys with Cu on the surface of the particles of the Cu-based metal powder and forms Cu₆Sn₅ intermetallic compounds. The CuSn compounds have a high melting point of 415° C., so the resulting solder layer as a whole exhibits good heat resistance.

When the above solder paste is applied to one side of a lid material in sheet form and heated in this manner, the solvent of the flux vaporizes and the solids of the flux remain as flux residue on the surface of the resulting solder layer. If even a small amount of the flux residue remains in the functional part, the flux residue has an adverse effect on the performance of the functional part. Therefore, it is necessary to completely remove the flux residue by cleaning. When cleaning the flux residue, an organic solvent such as an alcohol is used if the solids of the flux are resin based, and an aqueous solvent is used if the solids are water soluble.

The lid material in sheet form obtained after cleaning is formed into a flat lid or a cap-shaped lid by a suitable means such as punching, and optionally press working in accordance with the desired shape and dimensions of the lid.

In a preferred embodiment of a process for manufacturing a lid according to the present invention, the above-described application step, heating step, cleaning step, and forming step can be continuously carried out on a strip of a lid material in sheet form, and a lid having a desired shape and dimensions can be manufactured from the strip of a lid material having a solder layer as described above on its entire surface by forming means such as punching or punching and press forming. Using such a lid, a lid made from a difficult to solder material can be soldered to a package without using flux.

### EXAMPLES

A process for manufacturing a lid according to the present invention was carried out as illustrated in the drawings.

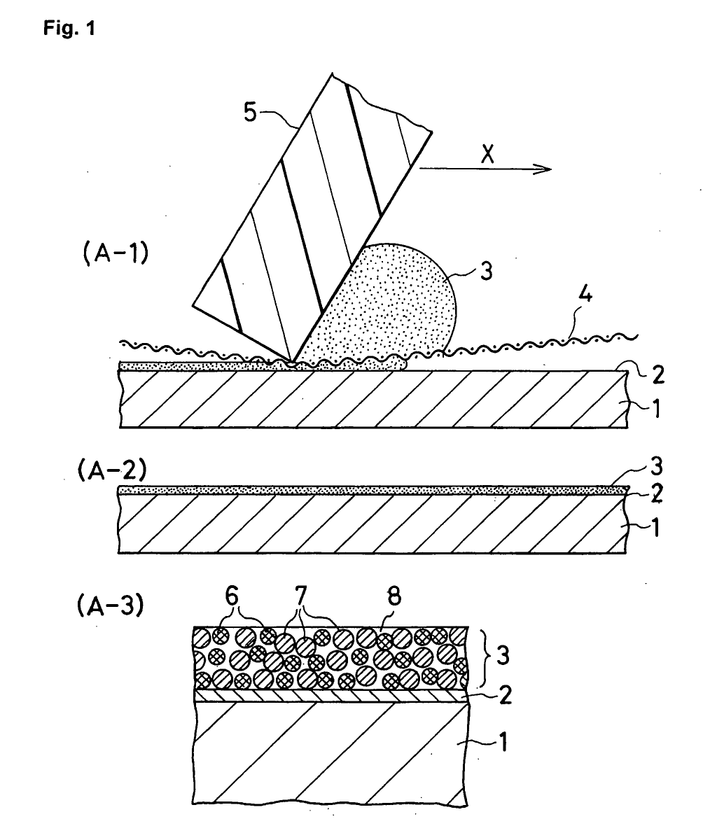

FIGS. 1-4 explain the individual steps in a process for manufacturing a lid according to the present invention.

One example of a lid material in sheet form, plating for a lid, and a solder paste used in this example of a process for manufacturing a lid was as follows.

Lid material in sheet form: Kovar (strip with a thickness of 0.1 mm and a width of 40 mm)

Plating of lid material: Ni underplating (thickness of 0.1 μm) and Sn plating (thickness of 3 μm) by electroless plating

Solder paste:
Pure Cu powder (Cu-based metal powder): 27 mass % (average particle diameter of 7 μm)
Pure Sn powder (lead-free solder powder): 63 mass % (average particle diameter of 10 μm)

Flux: 10 mass %

Flux Composition:
Resin (polymerized rosin): 56 mass %
Activator (diphenylguanidine HBr): 1 mass %
Thixotropic agent (hardened castor oil): 3 mass %
Solvent (diethylene glycol monobutyl ether): 40 mass %

### (A) Solder Paste Applying Step

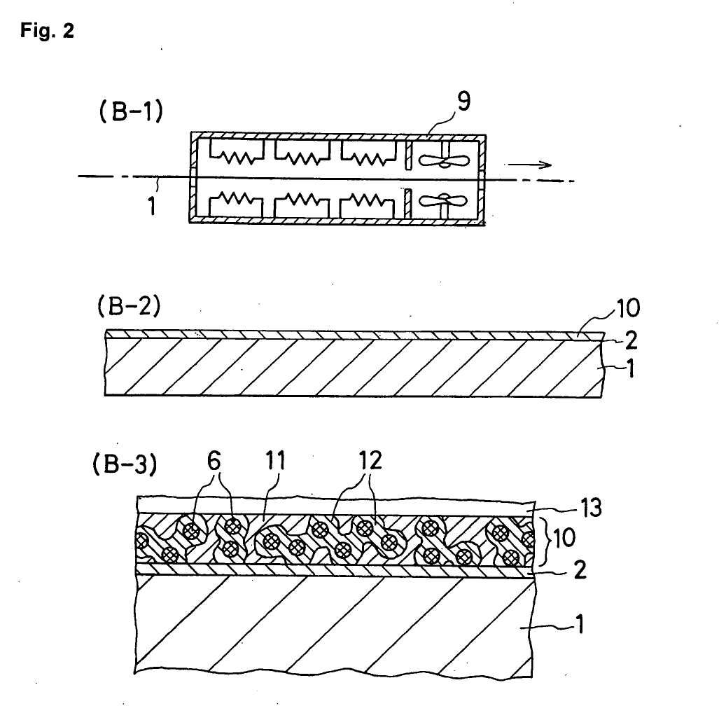

FIG. 1 shows a solder paste applying step of a process for manufacturing a lid according to the present invention. FIG. 1(A-1) is a schematic explanatory view of this applying step, FIG. 1(A-2) is a schematic view of the lid cross section after application, and FIG. 1(A-3) is an enlarged view thereof.

The solder paste applying step is a step of applying a solder paste 3 to the plated surface 2 of a lid material 1 in sheet form.

A screen 4 is disposed atop the plated surface 2 of the lid material 1, a solder paste 3 is placed atop the screen, and the solder paste is scraped with a squeegee 5 in the direction of arrow X. The thickness of the applied solder paste is 40 μm. See FIG. 1 (A-1).

When the screen is removed from atop the lid material 1, the plated surface 2 of the lid 1 is coated with a solder paste 3 having a predetermined thickness. See FIG. 1(A-2).

If this figure is enlarged, it can be seen that the solder paste 3 has pure Cu powder 6, Sn powder 7, and flux 8 mixed therein. See FIG. 1(A-3).

### (B) Heating Step

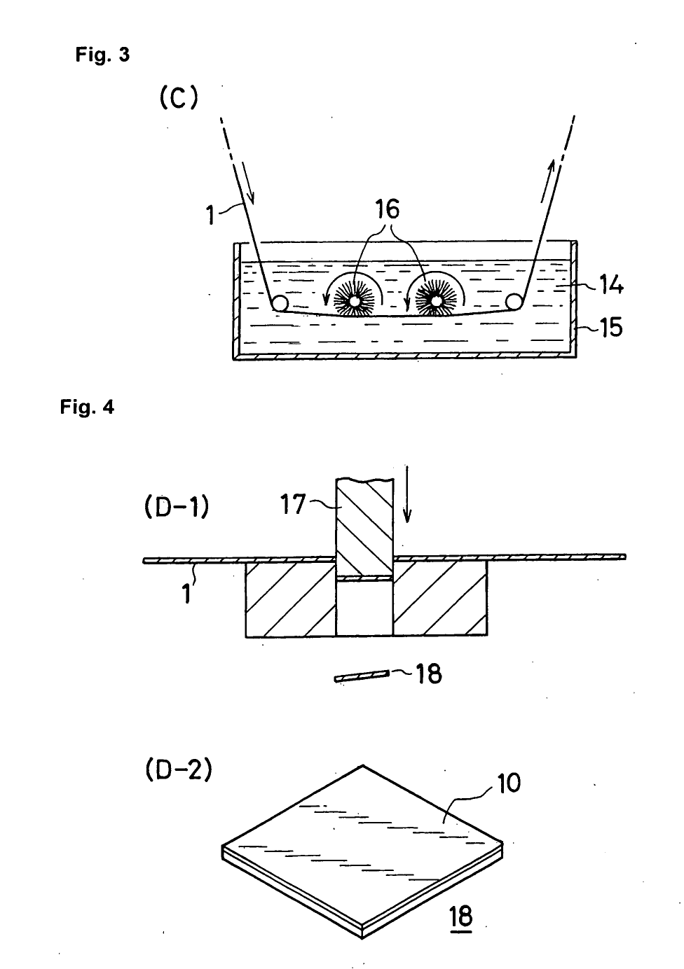

FIG. 2 is an explanatory view of a heating step in the process according to the present invention. FIG. 2(B-1) is a schematic explanatory view of a heating furnace in the form of a reflow furnace, FIG. 2(B-2) is a schematic explanatory view of a cross section of the material after passing through the heating step, and FIG. 2(B-3) is an enlarged view of a portion of the cross section.

When the lid material 1 to which solder paste has been applied is heated in a reflow furnace 9, the lead-free solder in the solder paste is melted and bonded to the plated surface, after which it is cooled and solidified. The heating temperature in the reflow furnace is a preheating temperature of 150° C. and a main heating temperature of 250° C. See FIG. 2(B-1).

A lead-free solder layer 10 with a thickness of 20 μm is formed on the plated surface 2 of the lid material 1 in sheet form. See FIG. 2(B-2).

In the solder layer 10, pure Cu powder 6 is dispersed in a matrix 11 of lead-free solder, the outer periphery of the Cu powder is alloyed with the lead-free solder, and the resulting CuSn compounds 12 formed by the alloying are present in the periphery of the Cu metal powder. The CuSn compounds 12 are bonded to the plating layer 2, and the CuSn compounds 12 are also bonded to each other. Not all of the CuSn compounds are bonded to each other, but at least a portion of the CuSn compounds are bonded to each other. Flux residue 13 of the solder paste is deposited atop the solder layer 10. See FIG. 2(B-3).

### (C) Cleaning Step

FIG. 3 is a schematic explanatory view of a cleaning step in the process of the present invention.

The strip of a lid material 1 having a solder layer provided on one side thereof and preferably over its entire surface is passed through a cleaning tank 15 containing alcohol 14 to clean off flux residue adhering to the lid material 1. Rotating brushes 16 are installed in the cleaning tank 15. Flux residue is dissolved by the alcohol and then is scraped off by the rotating brushes. See FIG. 3.

### (D) Lid-Forming Step

FIG. 4(D-1) is a schematic explanatory view of a step of forming a lid having a desired shape from the strip of a lid material, and FIG. 4(D-2) is a perspective view of a lid 18 which has been punched from the strip of a lid material 1.

Namely, the strip of a lid material 1 which has been cleaned to remove flux residue off undergoes punching with a press 17 to obtain a lid measuring 3.6 mm×3.6 mm. See FIG. 4(D-1).

The lid 18 which is formed by punching with a press has a solder layer 10 with a uniform thickness of 20 μm adhered to one side thereof. See FIG. 4(D-2).

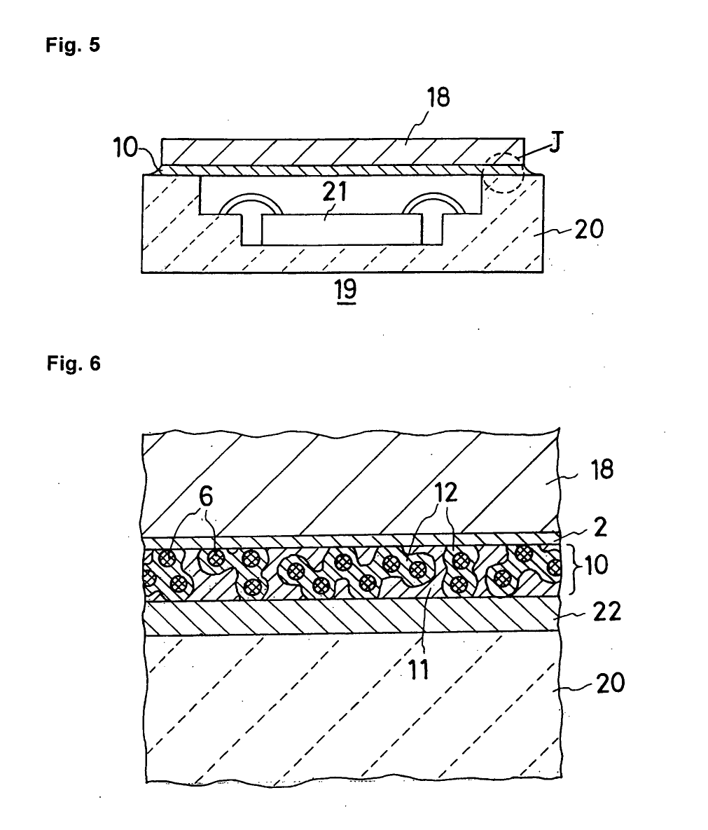

Next, a lid obtained by the above-described manufacturing process is mounted on a package to manufacture a functional part. FIG. 5 is a cross-sectional view of the functional part 19, and FIG. 6 is an enlarged cross-sectional view of the joint (J) between the package and the lid in FIG. 5.

The package 20 of the functional part 19 is box-shaped with a step formed in its interior, and an element 21 is housed in its interior. The upper peripheral edge of the package 20 is a frame-shaped portion to be soldered. The portion to be is soldered has a high melting point metal deposited thereon by metallization and a plating layer 22 atop the metallized surface of a metal to which soldering can be applied. The portion to be soldered of the package 20 and the lid 18 of the functional part 19 are joined by a solder layer 10.

A functional part 19 according to the present invention is fabricated by disposing the solder layer of the lid 18 atop the frame-shaped portion to be soldered of the package 20 followed by heating to join the package 20 and the lid to each other. As shown in FIG. 6, in the joint J of the functional part 19, the metal plating layer 2 of the lid 18 is bonded to the matrix 11 of the solder layer 10, and it is also bonded to the CuSn compounds 12 formed in the periphery of the Cu-based metal powder 6. Similarly, the plating layer 22 of the package 20 is bonded to the matrix 11 of the solder layer 10, and it is also bonded to the CuSn compounds 12 formed in the periphery of the Cu-based metal powder 6.

Since at least a portion of the CuSn compounds 12 in the solder layer 10 are connected to each other, the plating layer 2 of the lid 18 and the plating layer 22 of the package 20 are connected to each other by the CuSn compounds. Accordingly, the lid 18 and the package 20 are connected to each other by the matrix 11 and the CuSn compounds 12 through the metal plating layer 2 and the plating layer 22.

The melting point of Cu₆Sn₅ intermetallic compounds themselves is 415° C., but the melting point of these compounds in molten solder somewhat decreases depending on their proportion in the molten solder. According to experiments by the present inventors, when a composition of 30 mass % of Cu powder and 70 mass % of Sn powder was melted at 250° C., the resulting intermetallic compound had a peak temperature appearing at approximately 400° C.

Next, the Cu-based metal powder and the lead-free solder powder used in this example were changed in various ways, and lids manufactured by the above-described process were soldered to packages. The results are shown in Table 1.

TABLE 1

| | | | Particle | | Solder | Cu-based | | |
|---|---|---|---|---|---|---|---|---|
| | | Cu-based | diameter (μm) | | particle | metal | Thickness | |
| | | metal | of Cu-based | Lead-free solder | diameter | powder | of solder | Heat |
| | | powder | metal powder | powder | (μm) | (mass %) | paste (μm) | resistance |
| This Invention | 1 | Cu | 15 | Sn5Sb | 30 | 20 | 20 | ◯ |
| | 2 | Cu30Sn | 15 | Sn | 20 | 30 | 80 | ◯ |
| | 3 | Cu | 10 | Sn3.5Ag | 10 | 40 | 40 | ◯ |
| | 4 | Cu30Ag | 10 | Sn3Ag0.5Cu | 5 | 20 | 30 | ◯ |
| | 5 | Cu | 7 | Sn1Ag1Cu | 30 | 30 | 60 | ◯ |
| | 6 | Cu98Zn | 7 | Sn0.7Cu | 20 | 40 | 40 | ◯ |
| | 7 | Cu | 5 | Sn0.6Cu0.05Ni | 10 | 15 | 60 | ◯ |
| | 8 | Cu10Ni | 5 | Sn50Bi | 5 | 30 | 30 | ◯ |
| | 9 | Cu with | 10 | Sn4Ag | 10 | 30 | 40 | ◯ |
| | 10 | Cu with | 7 | Sn1Ag0.03Ni | 5 | 40 | 20 | ◯ |
| Comparative | 1 | — | — | Sn5Sb | 20 | — | 40 | X |
| | 2 | — | — | Sn10Sb | 30 | — | 30 | X |
| | 2 | — | — | Sn4Ag | 10 | — | 60 | X |
| | 3 | — | — | Sn10Cu | 20 | — | 40 | X |
| | 4 | — | — | Sn50Bi | 20 | — | 80 | X |
| | 5 | Cu70Sn | 15 | Sn3Ag0.5Cu | 20 | 40 | 40 | X |
| | 6 | Ag40Sn | 10 | Sn4Ag | 20 | 30 | 20 | X |
| | 7 | Cu with | 7 | Sn3Ag0.5Cu | 10 | 30 | 60 | X |

Functional parts were prepared from lids manufactured using solder layers having the compositions shown in Table 1. The lid of each functional part measured 3.6×3.6×0.1 (mm) and had Ni underplating and Sn plating atop the Ni underplating formed on one side of each lid by electroplating.

The package of each functional part measured 3.8×3.8×1.1 (mm), and the portion to be soldered was frame-shaped with a width of 0.45 mm. The portion to be soldered was metallized with W to a thickness of 10 μm, and it had a plating layer constituted by Ni underplating with a thickness of 1 μm formed atop the W metallization and Sn plating with a thickness of 0.5 μm formed atop the Ni underplating.

A solder layer with a thickness of 10-40 μm was formed on one side of each lid by applying a solder paste which comprised a lead-free solder, a Cu-based metal powder, and the above-described flux and which had the composition shown in Table 1 and then heating the lid in a reflow furnace. The lid was placed on the package such that the solder layer of the lid and the plating layer of the package were aligned with each other, and then a weight of 10 g was placed atop the lid. The assembled members were then heated in a reflow furnace in a nitrogen atmosphere at 30° C. above the liquidus temperature of the lead-free solder being used to join the lid to the package and manufacture a functional part.

A heat resistance test was carried out on 10 functional parts each having a lid joined to a package in this manner by heating the parts to 300° C. and then dropping the parts in a heated state from a height of 10 cm. If the soldered portion in each part did not have heat resistance, dropping caused the lid to come off.

This test was intended to simulate mounting a functional part on a printed circuit board by soldering which is carried out after soldering a lid to a package.

The test results are shown in Table 1.

The heat resistance in Table 1 is indicated by ◯ when the lids of all 10 functional parts remained in a predetermined position in the heat resistance test, and it is indicated by X when even one of the 10 functional parts had its lid removed or deviated in position.

Identification of SnCu compounds in the examples was carried out using an x-ray analyzer of a SEM. In each of the examples of the present invention, the formation of Cu₆Sn₅ intermetallic compounds was ascertained. It was also confirmed by observation of a cross section with a microscope that at least a portion of the intermetallic compounds were connected together.

From Table 1, it can be seen that with functional parts manufactured using a lid according to the present invention, the lids did not come off or deviate in position, but with functional parts manufactured using comparative examples of a lid, almost all of the lids fell off or deviated in position.

Comparative Examples 1-4 are examples which did not contain a Cu-based metal powder, Comparative Example 5 is a case in which the solidus temperature of a Cu-based metal powder was less than 400° C., Comparative Example 6 contained a metal powder which was not a Cu-based metal powder, and Comparative Example 7 shows an example in which Cu powder was plated with a large plating thickness (6 weight %). In each case, the heat resistance was inadequate, but particularly in the case of Comparative Example 6, which was an Ag-40Sn solder (solidus temperature of 221° C.), CuSn compounds were not formed, so heat resistance could not be obtained.

1. A lid for a functional part which is bonded to a package using solder, wherein the lid comprises a plating layer of a metal having good solderability provided on one side of the lid and a solder layer having a thickness of 5-40 μm which is formed on the surface of the plating layer and which comprises a Cu-based metal powder having a solidus temperature of at least 400° C., Cu₆Sn₅ intermetallic compounds, and an Sn-containing lead-free solder, and in the solder layer, the Cu-based metal powder is dispersed in the matrix of the lead-free solder, the Cu₆Sn₅ intermetallic compounds are present in the periphery of the Cu-based metal powder, the intermetallic compounds are bonded to the plated surface, and at least a portion of the intermetallic compounds are connected to each other.

2. A lid for a functional part as set forth in claim 1 wherein the metal having good solderability is selected from any of Sn, Cu, Ag, Sn—Cu alloys, and Sn—Ag alloys.

3. A lid for a functional part as set forth in claim 1 wherein the Cu-based metal powder is pure Cu powder or a Cu-based alloy powder.

4. A lid for a functional part as set forth in claim 1 wherein the Cu-based metal powder has Ni plating with a thickness of 0.03-0.3 μm formed thereon.

5. A lid for a functional part as set forth in claim 1 wherein the lead-free solder is pure Sn or an Sn-based alloy.

6. A process for manufacturing a lid for a functional part comprising:
(A) applying a uniform thickness of a solder paste comprising a Cu-based metal powder with a solidus temperature of at least 400° C., an Sn-containing lead-free solder powder, and a flux to a plated surface of a lid material in sheet form which is plated on one side thereof with a metal having good solderability;
(B) heating the lid material in sheet form having the solder paste applied thereto to at least the liquidus temperature of the lead-free solder and at most the solidus temperature of the Cu-based metal powder to form a solder layer on the plated surface of the lid material in sheet form with the Cu-based metal powder being dispersed in the matrix of the lead-free solder of the solder layer, and with Cu₆Sn₅ intermetallic compounds being present in the periphery of the Cu-based metal powder and with the intermetallic compounds being bonded to the lid material in sheet form and with at least a portion of the intermetallic compounds being connected to each other;
(C) cleaning the lid material in sheet form having the solder layer formed on one side thereof with a cleaning fluid to completely remove flux residue; and
(D) subjecting the lid material in sheet form from which the flux residue was removed to working to form a lid having a predetermined shape.

7. A process for manufacturing a lid for a functional part as set forth in claim 6 wherein the metal plating having good solderability is selected from any of Sn, Cu, Ag, Sn—Cu alloys, and Sn—Ag alloys.

8. A process for manufacturing a lid for a functional part as set forth in claim 6 wherein the Cu-based metal powder is pure Cu powder or a Cu-based alloy powder.

9. A process for manufacturing a lid for a functional part as set forth in claim 6 wherein the Sn-containing lead-free solder is pure Sn or an Sn-based alloy.
